(19) United States
(12) Patent Application Publication
(10) Pub. No.: US 2026/0103028 A1
(43) Pub. Date: Apr. 16, 2026

(54) TYRE FOR RACING BICYCLE WHEELS

(71) Applicant: Pirelli Tyre S.p.A., Milano (IT)

(72) Inventors: Nicolò TOMIATI, Milano (IT); Filippo GALLI, Abu Dhabi (AE); Michele GIBELLI, Milano (IT)

(73) Assignee: Pirelli Tyre S.p.A., Milano (IT)

(21) Appl. No.: 19/113,295

(22) PCT Filed: Sep. 21, 2023
(86) PCT No.: PCT/IB2023/059331

§ 371 Date: Mar. 19, 2025

(30) Foreign Application Priority Data
Sep. 26, 2022 (IT) 102022000019704

(51) Int. Cl. B60C 9/02; B60C 9/09

(52) U.S. Cl. CPC B60C 9/0207; B60C 9/09; B60C 2200/12

(57) ABSTRACT

A tyre (100) for racing bicycle wheels comprises a carcass structure (2) and a tread band (6) arranged in a radially outer position with respect to the carcass structure (2); wherein the carcass structure (2) comprises a single carcass ply (3) turned around annular anchoring structures (4a, 4b) and wherein free edges (11) of the carcass ply (3) are radially juxtaposed over one another. A protective layer (16) has a width equal to or less than 50% of the width of the tyre (100). A first sidewall reinforcing ply (14) and a second sidewall reinforcing ply (15) are axially arranged between a respective annular anchoring structure (4a, 4b) and an equatorial plane (X) of the tyre. In a first area of juxtaposition (17), the protective layer (16), the first sidewall reinforcing ply (14) and the portion of juxtaposition (12) of edges of carcass ply are radially juxtaposed according to a predetermined order. In a second area of juxtaposition (18), the protective layer (16), the second sidewall reinforcing ply (15) and the portion of juxtaposition (12) of edges of carcass ply are radially juxtaposed according to a predetermined order. The first area of juxtaposition (17) and the second area of juxtaposition (18) are arranged at respective distances from the equatorial plane (X) comprised between 3% and 24% of the width of the tyre (100).

The present invention relates to a tyre for bicycle wheels, preferably for racing bicycle wheels.

Racing bicycles are high-performance bicycles for road or track competitions. Such bicycles include those that satisfy the rules established by the Union Cycliste Internationale (UCI)—Part I—General Organisation of Cycling as a Sport—Chapter 3: Equipment Section 2. Such bicycles also include recumbent bicycles, time trial and/or triathlon bicycles. Also included are so-called “fitness bikes” (racing bicycles for recreational use).

Tyres for racing bicycle wheels have usage inflation pressure of over 3 bar, more preferably over 4 bar and, depending on the weight of the cyclist and the width of the tyre they can reach inflation pressures equal to or greater than 8 bar.

Tyres for racing bicycle wheels have a fitting diameter less than, or equal to, about 622 mm (which can correspond to an outer diameter comprised between about 675 and about 700 millimeters depending on the width of the tyre) and width of the inflated tyre comprised between about 23 millimeters and 35 millimeters.

### PRIOR ART

A tyre for bicycle wheels typically comprises a carcass structure turned around a pair of bead cores and a tread band arranged in a radially outer position with respect to the carcass structure.

The carcass structure is intended to withstand the inflation pressure and to support the weight of the bicycle and of the cyclist. It comprises one or more carcass plies, each comprising a plurality of suitably oriented reinforcing cords. In the case of a tyre for racing bicycle wheels a single carcass ply is usually provided turned around the pair of bead cores so as to make three carcass ply layers radially juxtaposed over one another at the tread band.

The tread band is intended to allow the tyre to grip the asphalt.

The bead cores, also defined as annular anchoring structures, have the task of ensuring the anchoring of the tyre to the rim of the wheel.

In radially inner position with respect to the carcass structure an air chamber is typically provided in which pressurized air is introduced.

However, there are types of tyres called “tubeless”, i.e. without an air chamber. In such tyres the pressurized air acts directly on the carcass structure and a layer called “liner” is provided that extends between the pair of bead cores and that is arranged radially between the carcass structure and the tread band or, alternatively, in radially inner position with respect to the carcass, to allow the airtight seal. The carcass structure, the annular anchoring structures and the rim of the wheel are shaped so that their mutual anchoring ensures the airtight seal.

There is a further type of tyre called “tubeless ready”, without an air chamber and in which the “liner” is replaced by a ply from bead core to bead core that extends between the pair of bead cores (called “bead to bead”). The ply from bead core to bead core is arranged radially between the tread band and the carcass structure. The airtight seal is ensured by a sealant that is inserted between the tyre and the rim of the bicycle and that forms a thin airtight film. The carcass structure, the annular anchoring structures and the rim of the wheel are shaped so that their mutual anchoring ensures the airtight seal.

In order to avoid the penetration of debris into the carcass structure and, consequently, the puncturing of the possible air chamber and/or the damaging of the carcass structure itself, in radially inner position with respect to the tread band a protective layer can be provided (also known as “anti-puncture layer” or “breaker”). Such a protective layer can be arranged radially inside the carcass structure or be radially arranged between the carcass structure and the tread band.

Tyres for bicycle wheels are known for example from EP 0 484 831, from EP 3 575 109 and from FR 3067982.

### SUMMARY OF THE INVENTION

The term “equatorial plane” of the tyre is meant to indicate a plane perpendicular to the rotation axis of the tyre and that divides the tyre into two symmetrically equal parts.

The terms “radial” and “axial” and the expressions “radially inner/outer” and “axially inner/outer” are used with reference respectively to a direction perpendicular to and to a direction parallel to the rotation axis of the tyre.

The expressions “axially inner” and “axially outer” indicate a position respectively closer to, and further from, the equatorial plane.

The expressions “radially inner” and “radially outer” indicate a position respectively closer to, and further from, the rotation axis of the tyre.

The terms “circumferential” and “circumferentially” are used with reference to the direction of annular extension of the tyre, i.e. to the rolling direction of the tyre, which corresponds to a direction lying on a plane coinciding with or parallel to the equatorial plane of the tyre.

The term “elastomeric material” is meant to indicate a composition comprising at least one elastomeric polymer and at least one reinforcing filler. Preferably, such a composition also comprises additives like, for example, a cross-linking agent and/or a plasticizer. Thanks to the presence of the cross-linking agent, such a material can be cross-linked through heating.

The term “cord”, or the expression “reinforcing cord” is meant to indicate an element consisting of one or more thread-like elements (hereinafter also called “threads”) possibly coated by, or incorporated in, a matrix of elastomeric material.

The term “diameter” of a cord or of a thread is meant to indicate the thickness of the cord or of the thread measured as prescribed by the BISFA E10 method (The International Bureau For The Standardization Of Man-Made Fibres, Internationally Agreed Methods For Testing Steel Tyre Cords, 1995 edition).

The term “thread count” of a layer or of a ply or of a fabric is meant to indicate the number of reinforcing cords per unit length present in such a layer/ply/fabric. Thread count is measurable in TPI (threads per inch).

The term “linear density” or “count” of a cord or of a thread is meant to indicate the weight of the reinforcing cord per unit length. The linear density is measurable in dtex (grammes per 10 km of length).

The term “fitting diameter” of a tyre is meant to indicate the diameter of the tyre measured at the inner diameter of the bead cores for anchoring the tyre to the rim of the wheel, as prescribed in ETRTO (The European Tyre and Rim Technical Organization) or ISO (International Organization for Standardization).

The term “width” of a tyre is meant to indicate the maximum axial extension of the development of the tyre on a reference plane perpendicular to the equatorial plane of the tyre and tangent to the maximum diameter of the tyre, such a width being measured between the axially outer points of said development of the tyre on said reference plane.

The term “width” of a component of the tyre is meant to indicate the maximum axial extension of such a component measured along the development of the tyre on a plane perpendicular to the equatorial plane of the tyre and tangent to the maximum diameter of the tyre.

The term “rolling resistance” is meant to indicate the force that opposes the rolling of the tyre and, in more general terms, the energy dissipated by the tyre when rolling per unit distance travelled. The measurement of the rolling resistance can be carried out, for example, according to the method described hereinafter.

The term “radius of curvature” of a portion of the profile of a cross section of the tyre is meant to indicate the radius of the circumference that best approximates that portion of profile.

The term “inflated profile” of the tyre is meant to indicate the shape of the radially outer profile of a cross section of the tyre when the tyre is inflated to an operating pressure.

The term “width of the inflated tyre” is meant to indicate the maximum axial extension (or “maximum cord”) of the tyre, measured when the tyre is inflated to an operating pressure. The width of the inflated tyre corresponds to the width of the projection of the tyre on a plane perpendicular to the equatorial plane of the tyre and tangent to the maximum diameter of the tyre, such a width corresponding to the size of the segment having as extremities the two axially outermost points of the tyre when inflated to the operating pressure.

In the rest of the present description and in the subsequent claims, when reference is made to certain numerical values, such numerical values must be deemed to be preceded by the term “about”.

In the rest of the present description and in the subsequent claims, when reference is made to certain ranges of numerical values, the extreme values are included in such ranges of numerical values.

The Applicant has observed that for the optimization of the performance of the tyres for bicycle wheels, it is necessary to take into account many requirements, which are interconnected with one another and in some cases in conflict with each other.

The Applicant has noted that, in the specific case of tyres for racing bicycle wheels, there is a need for high maneuverability even at relatively high speeds and low weight and low rolling resistance.

The Applicant has noted that the maneuverability of the bicycle (precision of trajectory, reactivity and control in traction and braking, resistance to lateral thrusts) usually increases as the structural rigidity of the tyre increases.

In the experience of the Applicant, greater structural rigidity can be obtained by increasing the inflation pressure of the tyre, however an inflation pressure that is too high impacts negatively on other important performance features of the tyre, such as road holding, i.e. the ability to maintain trajectory in a bend, and comfort, i.e. the ability to absorb the undulations and irregularities of the road surface, giving the cyclist the sense of reduced safety and reduced maneuverability.

Moreover, since the current tendency is to increase the width of the tyre and since, under the same conditions, a wider tyre requires lower inflation pressures, the Applicant deems that it is not suitable to seek greater structural rigidity of the tyre by increasing the inflation pressure.

In the experience of the Applicant, it would be possible to increase the structural rigidity of the tyre by increasing the number of carcass plies, but an increase in the number of carcass plies results in an increase in the weight of the tyre and an increase in the size of the suspended masses with consequent reduction of the perceived maneuverability.

Moreover, the Applicant has observed that as the number of carcass plies increases and therefore as the structural rigidity of the entire tyre increases, the inflated profile of the tyre tends to have radii of curvature of the radially outer profile of the tyre that are less at the portion of tread band that makes contact with the ground during travel in a straight line. In such a portion the tread band is indeed radially larger with respect to portions of the tread band that make contact with the ground during cornering.

In the experience of the Applicant, this can cause a non-homogeneous passage between travel in a straight line and cornering that gives a feeling of poor predictability and therefore a perceived low maneuverability.

The Applicant has perceived that by providing the tyre with a high number of radially juxtaposed structural components at areas that make contact with the ground during cornering and with a lower number of juxtaposed structural components at the area that makes contact with the ground during travel in a straight line, it would be possible, on the one hand, to increase the structural rigidity of the tyre only in the areas of tyre that are more stressed during cornering and, on the other hand, to increase the radius of curvature of the radially outer profile of the tyre at the portion of tyre that makes contact with the ground during travel in a straight line.

The Applicant has found that this can increase maneuverability by providing the tyre with an increased structural rigidity during cornering and can make the radius of curvature of the radially outer profile of the tyre more constant at the tread band making the passage between travel in a straight line and cornering less sudden and thus making behavior during cornering more predictable.

The Applicant has finally found that if portions of structural components already provided in tyres for racing bicycle wheels were radially juxtaposed instead of juxtaposing new or further structural components to make areas of increased structural rigidity, the weight of the tyre would not be negatively affected.

Therefore, the present invention refers to a tyre for racing bicycle wheels, comprising a carcass structure and a tread band arranged in a radially outer position with respect to the carcass structure.

Preferably, the carcass structure comprises a single carcass ply turned around a first annular anchoring structure and around a second annular anchoring structure and wherein free edges of the carcass ply are radially juxtaposed over one another at a portion of juxtaposition of edges of carcass ply.

Preferably, a protective layer is provided having a width equal to or less than 50% of the width of the tyre.

Preferably, a first sidewall reinforcing ply is provided axially arranged between the first annular anchoring structure and an equatorial plane of the tyre.

Preferably, a second sidewall reinforcing ply is provided axially arranged between the second annular anchoring structure and the equatorial plane.

Preferably, in a first area of juxtaposition, the protective layer, the first sidewall reinforcing ply and the portion of juxtaposition of edges of carcass ply are radially juxtaposed according to a predetermined order.

Preferably, in a second area of juxtaposition, the protective layer, the second sidewall reinforcing ply and the portion of juxtaposition of edges of carcass ply are radially juxtaposed according to a predetermined order.

Preferably, the first area of juxtaposition and the second area of juxtaposition are arranged on axially opposite sides with respect to the equatorial plane at respective distances from the equatorial plane comprised between 3% and 24% of the width of the tyre.

The Applicant has found that the arrangement of the first area of juxtaposition and of the second area of juxtaposition at respective distances from the equatorial plane comprised between 3% and 24% of the width of the tyre provides the tyre with increased structural rigidity in the portions of tyre that make contact with the ground when the cyclist enters a bend and during cornering, increasing the precision of the trajectory in the curve and the resistance to lateral thrusts.

Moreover, said arrangement of the first area of juxtaposition and of the second area of juxtaposition does not involve or hardly involves the portion of tyre that makes contact with the ground during travel in a straight line and that typically has the portion of tread band with higher radius of curvature. The Applicant has found that in this way the thickness in the radial direction of the structure of the tyre radially inside the tread band is less at the portion of tread band that makes contact with the ground during travel in a straight line with respect to the portion of tread band that makes contact with the ground during cornering. This allows to obtain a radius of curvature of the radially outer profile of the tyre that is constant, or substantially constant or in any case very similar, between the portions of tyre that make contact with the ground during travel in a straight line and during cornering. In this way, the transition between travel in a straight line and cornering (and vice-versa) is very gradual, substantially increasing comfort and the feeling of safety and maneuverability of the cyclist.

The present invention can present at least one of the preferred characteristics described hereinafter.

Preferably, the protective layer is made from a ply.

Preferably, in said first area of juxtaposition and in said second area of juxtaposition the tyre comprises five radially juxtaposed plies.

Preferably, in axially intermediate position between said first area of juxtaposition and said second area of juxtaposition the tyre comprises four radially juxtaposed plies.

Preferably, the carcass structure is a carcass structure of the mono-ply type.

Preferably, the first area of juxtaposition and the second area of juxtaposition are arranged on axially opposite sides with respect to the equatorial plane at respective distances from the equatorial plane equal to or greater than 3% of the width of the tyre.

Preferably, the first area of juxtaposition and the second area of juxtaposition are arranged on axially opposite sides with respect to the equatorial plane at respective distances from the equatorial plane equal to or greater than 5% of the width of the tyre.

Preferably, the first area of juxtaposition and the second area of juxtaposition are arranged on axially opposite sides with respect to the equatorial plane at respective distances from the equatorial plane equal to or less than 20%, preferably of the width of the tyre.

Preferably, the first area of juxtaposition and the second area of juxtaposition are arranged on axially opposite sides with respect to the equatorial plane at respective distances from the equatorial plane equal to or less than 18% of the width of the tyre.

Preferably, the first area of juxtaposition and the second area of juxtaposition are arranged on axially opposite sides with respect to the equatorial plane at respective distances from the equatorial plane comprised between 3% and 20% of the width of the tyre.

Preferably, the first area of juxtaposition and the second area of juxtaposition are arranged on axially opposite sides with respect to the equatorial plane at respective distances from the equatorial plane comprised between 3% and 18% of the width of the tyre.

Preferably, the first area of juxtaposition and the second area of juxtaposition are arranged on axially opposite sides with respect to the equatorial plane at respective distances from the equatorial plane comprised between 5% and 20% of the width of the tyre.

Preferably, the first area of juxtaposition and the second area of juxtaposition are arranged on axially opposite sides with respect to the equatorial plane at respective distances from the equatorial plane comprised between 5% and 18% of the width of the tyre.

Preferably, said tread band has a width equal to or less than 50% of the width of the tyre, more preferably equal to or less than 45% of the width of the tyre.

Preferably, said tread band has a width equal to or greater than 30% of the width of the tyre, more preferably equal to or greater than 35% of the width of the tyre.

Preferably, said tread band has a width comprised between 30% and 50% of the width of the tyre, more preferably comprised between 35% and 50% of the width of the tyre, even more preferably comprised between 30% and 45% of the width of the tyre, even more preferably comprised between 35% and 45% of the width of the tyre, for example about 40% of the width of the tyre.

Preferably, said protective layer has a width equal to or less than 50% of the width of the tyre.

Preferably, said protective layer has a width equal to or greater than 20% of the width of the tyre, more preferably equal to or greater than 22% of the width of the tyre.

Preferably, said protective layer has a width comprised between 20% and 45% of the width of the tyre, more preferably comprised between 22% and 40% of the width of the tyre, even more preferably comprised between 22% and 35% of the width of the tyre.

In order to allow adequate resistance to puncture of the tyre, at the same time keeping down the weight of the tyre, the Applicant has observed that it is advantageous for said protective layer to have a width equal to, preferably less than, the width of the tread band.

Preferably, the protective layer has a width equal to or less than 95% of the width of the tread band, more preferably equal to or less than 90% of the width of the tread band, even more preferably equal to or less than 85% of the width of the tread band.

Preferably, the protective layer has a width equal to or more than 50% of the width of the tread band, more preferably equal to or more than 60% of the width of the tread band, more preferably equal to or more than 70% of the width of the tread band, even more preferably equal to or more than 75% of the width of the tread band.

Preferably, the protective layer has a width comprised between 50% and 95% of the tread band, more preferably comprised between 50% and 90% of the tread band, even more preferably comprised between 50% and 85% of the tread band.

Preferably, the protective layer is symmetrically arranged with respect to the equatorial plane.

Preferably, the first area of juxtaposition and the second area of juxtaposition are symmetrically arranged on axially opposite sides with respect to the equatorial plane.

In order to improve the structural strength of the tyre in the portions of tyre that make contact with the ground when the cyclist enters a bend and during cornering and to further contain the weight of the tyre, the Applicant has observed that it is advantageous to provide for widths of the first area of juxtaposition and of the second area of juxtaposition that are not overall equal to or greater than 22% of the width of the tyre.

Preferably, the first area of juxtaposition and the second area of juxtaposition each have a width equal to or less than 10% of the width of the tyre.

Preferably, the first area of juxtaposition and the second area of juxtaposition each have a width equal to or greater than 0.5% of the width of the tyre, more preferably equal to or greater than 2% of the width of the tyre, even more preferably equal to or greater than 5% of the width of the tyre.

Preferably, the first area of juxtaposition and the second area of juxtaposition each have a width comprised between 0.5% and 10% of the width of the tyre, more preferably comprised between 2% and 10% of the width of the tyre, even more preferably comprised between 5% and 10% of the width of the tyre.

Preferably, the portion of juxtaposition of edges of carcass ply has a width equal to or less than 50% of the width of the tyre, more preferably equal to or less than 40% of the width of the tyre.

Preferably, the portion of juxtaposition of edges of carcass ply has a width equal to or greater than 10% of the width of the tyre, more preferably equal to or greater than 20% of the width of the tyre.

Preferably, the portion of juxtaposition of edges of carcass ply has a width comprised between 10% and 50% of the width of the tyre, more preferably comprised between 20% and 40% of the width of the tyre.

Preferably, said protective layer has a width equal to, preferably less than, the width of the portion of juxtaposition of edges of carcass ply.

Preferably, the portion of juxtaposition of edges of carcass ply is symmetrically arranged with respect to the equatorial plane.

Preferably, the first sidewall reinforcing ply is radially outer with respect to said carcass ply.

Preferably, the second reinforcing ply is radially outer with respect to said carcass ply.

Preferably, the protective layer is radially arranged between the tread band and a portion of the carcass ply that extends with continuity between the first annular anchoring structure and the second annular anchoring structure.

Preferably, the portion of juxtaposition of edges of carcass ply is radially outer with respect to the portion of the carcass ply that extends with continuity between the first annular anchoring structure and the second annular anchoring structure.

In a first embodiment the predetermined order of radial juxtaposition of the first area of juxtaposition and of the second area of juxtaposition is such that the protective layer is preferably radially arranged between the tread band and the portion of juxtaposition of edges of carcass ply.

In this embodiment, in the first area of juxtaposition the protective layer is preferably radially outer with respect to the first sidewall reinforcing ply and in the second area of juxtaposition the protective layer is preferably radially outer with respect to the second sidewall reinforcing ply.

Alternatively, in this embodiment, in the first area of juxtaposition the protective layer is preferably radially inner with respect to the first sidewall reinforcing ply and in the second area of juxtaposition the protective layer is preferably radially inner with respect to the second sidewall reinforcing ply.

In a second embodiment the predetermined order of radial juxtaposition of the first area of juxtaposition and of the second area of juxtaposition is such that the portion of juxtaposition of edges of carcass ply is preferably radially arranged between the tread band and the protective layer.

Preferably, the ratio between the width of the inflated tyre and the radius of curvature, at the tread band, of the inflated profile of the tyre is comprised between 2.0 and 2.4.

Preferably, the ratio between the width of the inflated tyre and the radius of curvature, at the tread band, of the inflated profile of the tyre is comprised between 2.0 and 2.2.

Preferably, a minimum radius of curvature of the inflated profile of the tyre at the tread band is equal to or more than 95% of a maximum radius of curvature of the inflated profile of the tyre at the tread band.

Preferably, the minimum radius of curvature of the inflated profile of the tyre at the tread band is substantially equal to the maximum radius of curvature of the inflated profile of the tyre at the tread band.

In order to minimize the weight of the tyre without compromising the structural rigidity of the tyre, the Applicant has observed that it is advantageous to provide for low thicknesses in the radial direction of the carcass ply.

Preferably, said carcass ply has a thickness in the radial direction less than or equal to 0.50 millimeters, more preferably less than or equal to 0.45 millimeters, even more preferably less than or equal to 0.40 millimeters.

Preferably, said carcass ply has a thickness in the radial direction greater than or equal to 0.10 millimeters, more preferably greater than or equal to 0.15 millimeters, even more preferably greater than or equal to 0.20 millimeters.

Preferably, said carcass ply has a thickness in the radial direction comprised between 0.15 and 0.45 millimeters, more preferably comprised between 0.20 and 0.40 millimeters, for example 0.30 millimeters.

In order to allow adequate resistance to puncture of the tyre also at the portion of tread band that makes contact with the ground during travel in a straight line, at the same time keeping down the weight of the tyre, the Applicant has observed that it is advantageous to provide for thicknesses in the radial direction of the protective layer that are greater than the thickness in the radial direction of the carcass ply.

Preferably, said protective layer has a thickness in the radial direction greater than or equal to 0.25 millimeters, more preferably greater than or equal to 0.30 millimeters, even more preferably greater than or equal to 0.35 millimeters.

Preferably, said protective layer has a thickness in the radial direction less than or equal to 0.55 millimeters, more preferably less than or equal to 0.50 millimeters, even more preferably less than or equal to 0.45 millimeters.

Preferably, said protective layer has a thickness in the radial direction comprised between 0.25 and 0.55 millimeters, more preferably comprised between 0.30 and 0.50 millimeters, for example 0.40 millimeters.

In order to minimize the weight of the tyre without compromising the structural rigidity of the tyre, the Applicant has observed that it is advantageous to provide for thicknesses in the radial direction of the first sidewall reinforcing ply and of the second sidewall reinforcing ply that are not greater than the thickness in the radial direction of the protective layer.

Preferably, said first sidewall reinforcing ply has a thickness in the radial direction greater than or equal to 0.15 millimeters, more preferably greater than or equal to 0.20 millimeters, even more preferably greater than or equal to 0.30 millimeters.

Preferably, said first sidewall reinforcing ply has a thickness in the radial direction less than or equal to 0.55 millimeters, more preferably less than or equal to 0.50 millimeters, even more preferably less than or equal to 0.45 millimeters.

Preferably, said first sidewall reinforcing ply has a thickness in the radial direction comprised between 0.15 and 0.55 millimeters, preferably comprised between 0.30 and 0.50 millimeters, for example 0.40 millimeters.

Preferably, said second sidewall reinforcing ply has a thickness in the radial direction greater than or equal to 0.15 millimeters, more preferably greater than or equal to 0.20 millimeters, even more preferably greater than or equal to 0.30 millimeters.

Preferably, said second sidewall reinforcing ply has a thickness in the radial direction less than or equal to 0.55 millimeters, more preferably less than or equal to 0.50 millimeters, even more preferably less than or equal to 0.45 millimeters.

Preferably, said second sidewall reinforcing ply has a thickness in the radial direction comprised between 0.15 and 0.55 millimeters, preferably comprised between 0.30 and 0.50 millimeters, for example 0.40 millimeters.

Preferably, said first sidewall reinforcing ply and said second sidewall reinforcing ply have equal thickness in the radial direction.

In order to further improve the structural strength of the tyre, the Applicant has also observed that it is advantageous to provide a plurality of reinforcing cords in the various layers of the tyre.

Preferably, said carcass ply comprises a plurality of reinforcing cords inclined, with respect to the equatorial plane, by a first angle greater than or equal to 25°, preferably greater than or equal to 30°.

Preferably, said carcass ply comprises a plurality of reinforcing cords inclined, with respect to the equatorial plane, by a first angle less than or equal to 70°, more preferably less than or equal to 60°.

Preferably, said carcass ply comprises a plurality of reinforcing cords inclined, with respect to the equatorial plane, by a first angle comprised between 30° and 60°.

In order to further improve the behavior of the tyre in terms of maneuverability, the Applicant has also observed that it is advantageous to provide a high thread count of reinforcing cords in the various layers of the tyre. A high thread count also results in a lower weight (due to the greater number of threads per unit length, which in turn results in a smaller amount of elastomeric material in the layer considered and a lower thickness of such a layer) and greater comfort (due to the greater flexibility of the threads).

Preferably, the carcass ply has a thread count greater than, or equal to, 15 TPI, more preferably greater than, or equal to, 30 TPI, even more preferably greater than, or equal to, 60 TPI, even more preferably, greater than, or equal to, 120 TPI.

Preferably, the carcass ply has a thread count less than, or equal to, 360 TPI, more preferably less than, or equal to, 300 TPI, even more preferably less than, or equal to, 240 TPI, even more preferably less than, or equal to, 200 TPI.

Preferably, the reinforcing cords of the carcass ply have a linear density greater than, or equal to, about 110 dtex, more preferably greater than, or equal to, about 230 dtex.

Preferably, the reinforcing cords of the carcass ply have a linear density less than, or equal to, about 1300 dtex, more preferably less than, or equal to, about 940 dtex.

Preferably, the protective layer comprises a square fabric with weft and warp textile fibers.

Preferably, the weft or warp textile fibers are oriented with respect to the equatorial plane with an angle greater than or equal to 25°, preferably greater than or equal to 30°, even more preferably greater than or equal to 45°.

Preferably, the tyre has an inflation pressure greater than or equal to 3.5 bar, more preferably greater than or equal to 4 bar, even more preferably greater than or equal to 5 bar.

Preferably, the tyre has a weight of less than 400 grammes, preferably less than 350 grammes, even more preferably less than 250 grammes.

### DESCRIPTION OF THE FIGURES AND OF PREFERRED EMBODIMENTS

Further characteristics and advantages of the tyre of the present invention will become clearer from the following detailed description of some preferred embodiments thereof, made with reference to the attached drawings. In such drawings:

FIG. 1 is a schematic perspective view of a tyre in accordance with the present invention with some parts removed to better highlight others;

FIG. 2 is a schematic axial section view of a tyre in accordance with the present invention; and

FIGS. 3 to 6 show possible schematic constructive schemes representative of alternative embodiments of the tyre in accordance with the present invention.

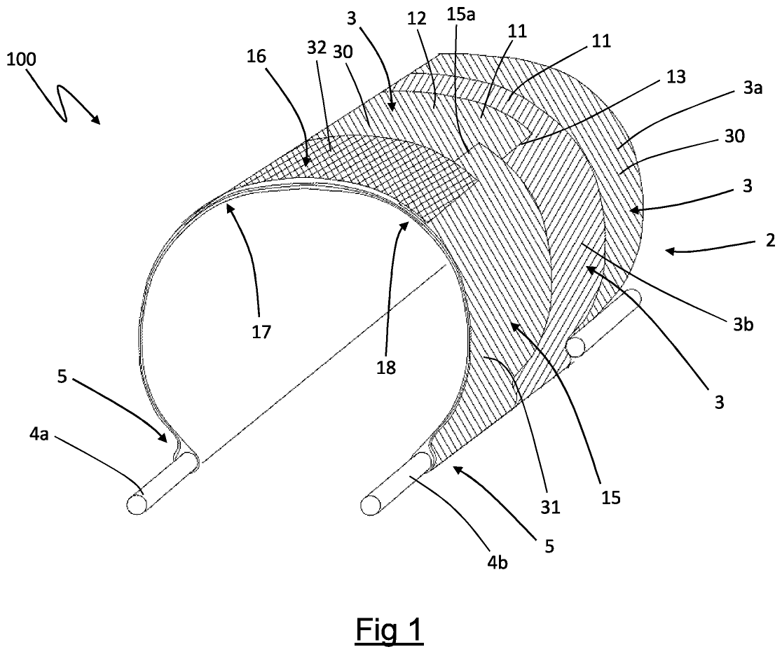

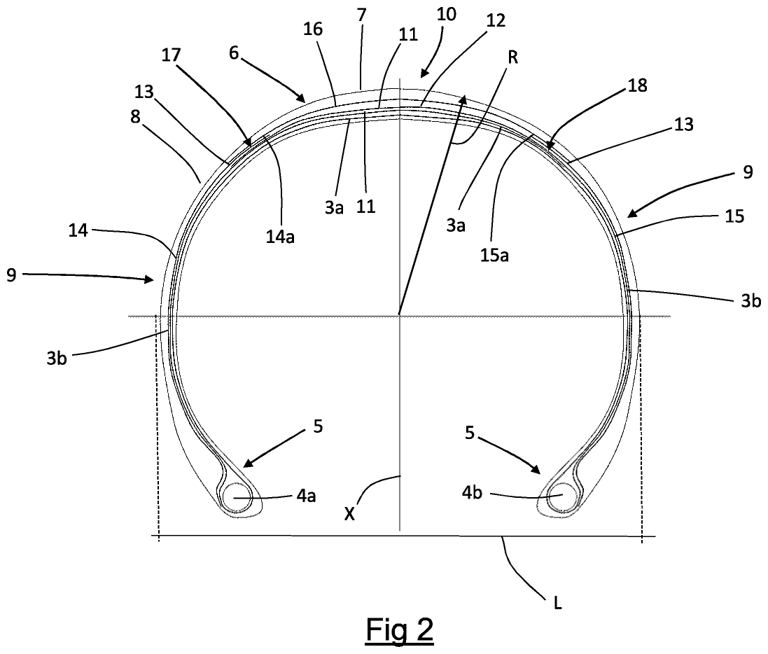

In FIGS. 1 and 2, reference numeral 100 wholly indicates a tyre for bicycle wheels according to the present invention. In particular, it concerns a tyre intended to be mounted on the wheels of a racing bicycle.

An equatorial plane X (FIG. 2) and a rotation axis (not illustrated) perpendicular to the equatorial plane X are defined in the tyre 100. An axial (or transversal, or lateral) direction, parallel to the rotation axis and a circumferential (or longitudinal) direction parallel to the equatorial plane X and corresponding to the rolling direction of the tyre 100 are also defined.

The tyre 100, once inflated, has a substantially toroidal shape.

The inflation pressure of the tyre mounted on the corresponding rim is greater than or equal to about 3.5 bar, more preferably greater than or equal to about 4 bar, even more preferably greater than or equal to about 5 bar.

The tyre 100 comprises a carcass structure 2 having a single carcass ply 3 (mono-ply tyre).

The carcass ply 3 is turned around a first annular anchoring structure 4a and on a second annular anchoring structure 4b, typically called “bead cores”.

The first annular anchoring structure 4a and the second annular anchoring structure 4b are preferably made of textile fibers with high elastic modulus, like for example aramid fibers (common name of aromatic polyamide fibers), so as to make a so-called “foldable” tyre. Alternatively, the first annular anchoring structure 4a and the second annular anchoring structure 4b can be made of metallic wires, like for example steel.

In radially outer position with respect to the carcass structure 2 a tread band 6 is provided, by means of which the contact of the tyre 100 with the road surface takes place.

The tread band 6 is made of a compound of elastomeric material preferably comprising at least one elastomeric diene polymer.

The tread band 6 comprises a central portion 7 and two lateral portions 8 (or sidewalls 8) arranged on axially opposite sides with respect to the central portion 7.

Preferably, said tread band has a width equal to or less than 50% of the width of the tyre, more preferably equal to or less than 45% of the width of the tyre.

Preferably, said tread band has a width equal to or greater than 30% of the width of the tyre, more preferably equal to or greater than 35% of the width of the tyre.

The tread band has a width comprised between 30% and 50% of the width of the tyre, for example about 40% of the width of the tyre.

The carcass ply 3 is turned around the first annular anchoring structure 4a and the second annular anchoring structure 4b so that two layers of carcass ply 3 are arranged at two opposite first portions 9 of the tyre that are preferably at least partially juxtaposed over the sidewalls 8 of the tread band 6. The carcass ply 3 also has three ply layers juxtaposed at a second portion 10 of the tyre 100 axially arranged between the first two portions 9 and preferably at least partially coinciding with the central portion 7 of the tread band 8.

The carcass ply 3 comprises two free edges 11 radially juxtaposed over one another at a portion of juxtaposition 12 of edges of carcass ply. Each free edge 11 comprises an end edge 13 that separates the portion with three juxtaposed ply layers from the respective portion with two juxtaposed ply layers of the carcass ply 3.

The two free edges 11 are radially outer with respect to a portion 3a of the carcass ply 3 that extends with continuity between the first annular anchoring structure 4a and the second annular anchoring structure 4b.

As illustrated in the attached figures, the cited three juxtaposed ply layers are defined by the portion 3a of the carcass ply 3 that extends with continuity between the first annular anchoring structure 4a and the second annular anchoring structure 4b, and by the two free edges 11 radially juxtaposed over one another. The cited two juxtaposed ply layers are defined by the portion 3a of the carcass ply 3 that extends with continuity between the first annular anchoring structure 4a and, respectively, by portions 3b of carcass ply 3 that extend between the respective radially juxtaposed free edges 11 and the respective annular anchoring structure 4a, 4b.

The portion of juxtaposition 12 of edges di carcass ply is symmetrically arranged with respect to the equatorial plane X, in other words the equatorial plane X ideally divides the portion of juxtaposition 12 of edges of carcass ply into two half-parts of equal width.

The portion of juxtaposition 12 of edges of carcass ply has a width equal to or less than 50% of the width of the tyre, more preferably equal to or less than 40% of the width of the tyre.

The portion of juxtaposition of edges of carcass ply has a width equal to or greater than 20% of the width of the tyre and equal to or less than 40% of the width of the tyre.

The portion of juxtaposition 12 of edges of carcass ply has a width less than the width of the tread band 6.

The carcass ply 3 has a thickness in the radial direction of less than 0.50 millimeters, and greater than 0.20 millimeters.

For example, the carcass ply 3 has a thickness in the radial direction of 0.30 millimeters.

The carcass ply 3 is preferably made of elastomeric material and comprises a plurality of reinforcing cords 30 arranged substantially parallel to one another. For the sake of clarity of illustration, in FIG. 1 reference numeral 30 is associated with the whole of the reinforcing cords illustrated.

The reinforcing cords 30 are preferably made from a textile material selected among Nylon, Rayon, PET, PEN, Lyocell, Aramid, in one or more pieces, preferably 1 or 2 pieces.

The reinforcing cords 30 have a diameter preferably comprised between 0.10 mm and 0.45 mm, more preferably between 0.12 mm and 0.35 mm, for example equal to 0.15 mm.

The reinforcing cords 30 have a linear density comprised between 110 dtex and 940 dtex, for example equal to 470 dtex.

Specific examples of textile materials able to be used for the aforementioned reinforcing cords 30 are as follows:
Nylon 930 dtex/1
Nylon 470 dtex/1
Nylon 230 dtex/1
Rayon 930 dtex/1
Rayon 470 dtex/1
Rayon 230 dtex/1
Aramid 470/1
where the number 1 after dtex indicates the number of pieces.

The reinforcing cords 30 are inclined, with respect to the equatorial plane of the tyre 100, by an angle comprised between about 30° and about 60°.

The carcass ply 3 preferably has a thread count comprised between 30 TPI and 300 TPI, for example equal to 240 TPI.

On the outer perimeter edge of the first annular anchoring structure 4a and of the second annular anchoring structure 4b it is possible to apply a respective tapered elastomeric filler that occupies the space defined between the carcass ply 3 and the first annular anchoring structure 4a and between the carcass ply 3 and the second annular anchoring structure 4b.

The area of the tyre comprising the first annular anchoring structure 4a or the second annular anchoring structure 4b and the possible elastomeric filler forms the so-called “bead”, globally indicated in FIG. 1 with 5, intended for the anchoring, through elastically forced fitting, of the tyre on a corresponding mounting rim, not illustrated.

At the first annular anchoring structure 4a and the second annular anchoring structure 4b it is possible to apply a reinforced band-shaped element 20, as illustrated in FIGS. 4 and 6. Such a reinforced band-shaped element 20 is radially arranged between the carcass ply 3 and the rim of the wheel when the tyre is mounted on such a rim. The reinforced band-shaped element 20 has a limited axial extension, preferably comprised between 2% and 15% of the width of the tyre 100. The reinforced band-shaped element 20 has the purpose of allowing adherence and friction with the rim, also avoiding possible damage due to abrasion as a result of rubbing of the carcass ply 3 with the rim. The reinforced band-shaped element 20 is also known by the name “chafer”.

In radially outer position with respect to the aforementioned carcass structure 2, a first sidewall reinforcing ply 14 and a second sidewall reinforcing ply 15 are provided.

The first sidewall reinforcing ply 14 is axially arranged between the first annular anchoring structure 4a and the equatorial plane X of the tyre and the second sidewall reinforcing ply 15 is axially arranged between the second annular anchoring structure 4b and the equatorial plane X.

The first sidewall reinforcing ply 14 and the second sidewall reinforcing ply 15 do not reach the equatorial plane X and are axially distanced from one another.

The first sidewall reinforcing ply 14 extends towards the equatorial plane X from the first annular anchoring structure 4a without being turned around the first annular anchoring structure 4a.

The second sidewall reinforcing ply 15 extends towards the equatorial plane X from the second annular anchoring structure 4b without being turned around the second annular anchoring structure 4b.

The width of the first sidewall reinforcing ply 14 is preferably comprised between 30% and 47% of the width of the tyre.

The width of the second sidewall reinforcing ply 15 is preferably comprised between 30% and 47% of the width of the tyre.

The first sidewall reinforcing ply 14 and the second sidewall reinforcing ply 15 have equal width.

The tread band 6 is radially juxtaposed at least over respective axially inner end edges 14a, 15a of the first sidewall reinforcing ply 14 and of the second sidewall reinforcing ply 15.

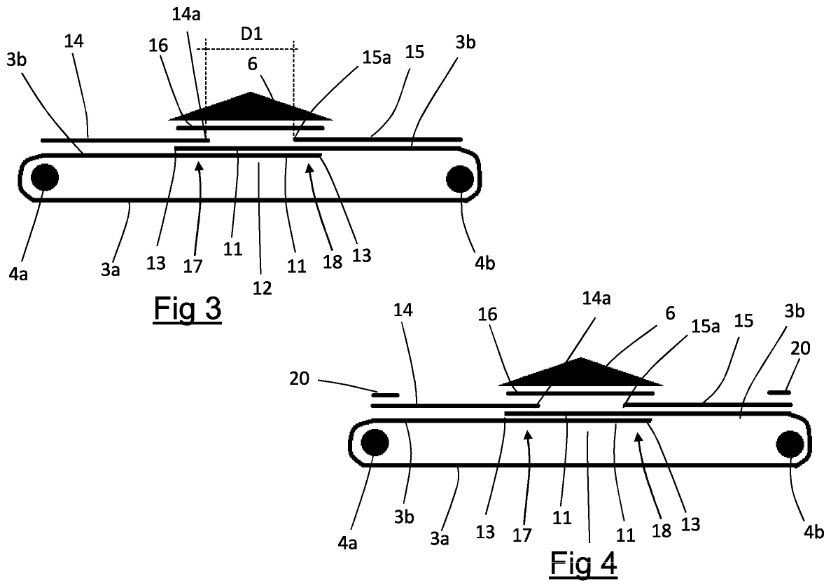

The axial distance D1 (FIG. 3) between the end edges 14a, 15a, proximal to the equatorial plane, of the first sidewall reinforcing ply 14 and of the second sidewall reinforcing ply 15 is equal to or more than 6% of the width of the tyre 100, preferably comprised between 6% and 20% of the width of the tyre 100.

The first sidewall reinforcing ply 14 and the second sidewall reinforcing ply 15 are radially juxtaposed over the portion of juxtaposition 12 of edges of carcass ply at least at the respective end edges 14a, 15a.

In the preferred embodiment of the present invention, the first sidewall reinforcing ply 14 and the second sidewall reinforcing ply 15 are radially juxtaposed over the portion of juxtaposition 12 of edges of carcass ply for respective portions having widths equal to or less than 10% of the width of the tyre 100.

The first sidewall reinforcing ply 14 and the second sidewall reinforcing ply 15 have a thickness in the radial direction comprised between 0.30 and 0.50 millimeters.

For example, the first sidewall reinforcing ply 14 and the second sidewall reinforcing ply 15 have a thickness in the radial direction of 0.40 millimeters.

The first sidewall reinforcing ply 14 and the second sidewall reinforcing ply 15 have equal thickness in the radial direction.

The first sidewall reinforcing ply 14 and the second sidewall reinforcing ply 15 are both made of elastomeric material and comprise a plurality of reinforcing cords 31.

For the sake of clarity of illustration, in FIG. 1 reference numeral 31 is associated with the whole of the reinforcing cords illustrated in relation to the second sidewall reinforcing ply 15.

The reinforcing cords 31 are preferably made from a textile material selected among Nylon, Rayon, PET, PEN, Lyocell, Aramid, in one or more pieces, preferably 1 or 2 pieces.

The reinforcing cords 31 have a diameter preferably comprised between 0.10 mm and 0.45 mm, more preferably between 0.12 mm and 0.35 mm, for example equal to 0.30 mm.

The reinforcing cords 31 have a linear density comprised between 230 dtex and 940 dtex, for example equal to 450 dtex.

Specific examples of textile materials able to be used for the aforementioned reinforcing cords 31 are as follows:
Nylon 930 dtex/1
Nylon 470 dtex/1
Nylon 230 dtex/1
Rayon 930 dtex/1
Rayon 470 dtex/1
Rayon 230 dtex/1
Aramid 470/1
where the number 1 after dtex indicates the number of pieces.

The reinforcing cords 31 can be inclined, with respect to the equatorial plane of the tyre 100, by an angle comprised between about 30° and about 60°.

Alternatively, the reinforcing cords 31 can make a square fabric structure (i.e. having warp reinforcing cords and weft reinforcing cords).

The cords 31 of the weft and warp are oriented with respect to the equatorial plane with an angle of 45°.

The first sidewall reinforcing ply 14 and the second sidewall reinforcing ply 15 preferably have a thread count comprised between 30 TPI and 240 TPI, more preferably comprised between 120 TPI and 200 TPI, for example equal to 60 TPI.

Between the tread band 6 and the portion 3a of the carcass ply 3 that extends with continuity between the first annular anchoring structure 4a and the second annular anchoring structure 4b a protective layer 16 is radially interposed.

The protective layer 16 can act as a protective layer to improve the resistance to puncture of the tyre 100.

The protective layer 16 is axially interposed between the first annular anchoring structure 4a and the second annular anchoring structure 4b and does not reach the first annular anchoring structure 4a and the second annular anchoring structure 4b.

The protective layer 16 is symmetrical with respect to the equatorial plane X and has a width comprised between 20% and 45% of the width of the tyre 100.

The protective layer 16 has a width that is less than the width of the tread band 6.

The protective layer 16 has a width that can be substantially equal to the width of the portion of juxtaposition 12 of edges of carcass ply.

The protective layer 16 has a thickness in the radial direction comprised between 0.30 and 0.50 millimeters.

For example, the protective layer 16 has a thickness in the radial direction of 0.40 millimeters.

The protective layer 16 is made of elastomeric material and comprises a plurality of reinforcing cords 32.

For the sake of clarity of illustration, in FIG. 1 reference numeral 32 is associated with the whole of the reinforcing cords.

The reinforcing cords 32 are preferably made from a textile material selected among Nylon, Rayon, PET, PEN, Lyocell, Aramid, in one or more pieces, preferably 1 or 2 pieces.

The reinforcing cords 32 have a diameter preferably comprised between 0.10 mm and 0.45 mm, more preferably between 0.12 mm and 0.35 mm, for example equal to 0.30 mm.

The reinforcing cords 32 have a linear density comprised between 230 dtex and 940 dtex, for example equal to 450 dtex.

Specific examples of textile materials able to be used for the aforementioned reinforcing cords 31 are as follows:
Nylon 930 dtex/1
Nylon 470 dtex/1
Nylon 230 dtex/1
Rayon 930 dtex/1
Rayon 470 dtex/1
Rayon 230 dtex/1
Aramid 470/1
where the number 1 after dtex indicates the number of pieces.

The reinforcing cords 32 make a square fabric structure (i.e. having warp reinforcing cords and weft reinforcing cords). The cords 32 of the weft and warp are oriented with respect to the equatorial plane with an angle equal to or greater than 45°.

The protective layer 16 preferably has a thread count comprised between 30 TPI and 240 TPI, more preferably comprised between 120 TPI and 200 TPI, for example equal to 60 TPI.

As schematically illustrated in FIGS. 3 and 4, the protective layer 16 can be radially arranged between the tread band 6 and the portion of juxtaposition 12 of edges of carcass ply.

In this case, the protective layer 16 can be arranged in one of the two following configurations:
radially outer with respect to the first sidewall reinforcing ply 14 and to the second sidewall reinforcing ply 15, as illustrated in FIGS. 3 and 4, or radially inner with respect to the first sidewall reinforcing ply 14 and to the second sidewall reinforcing ply 15.

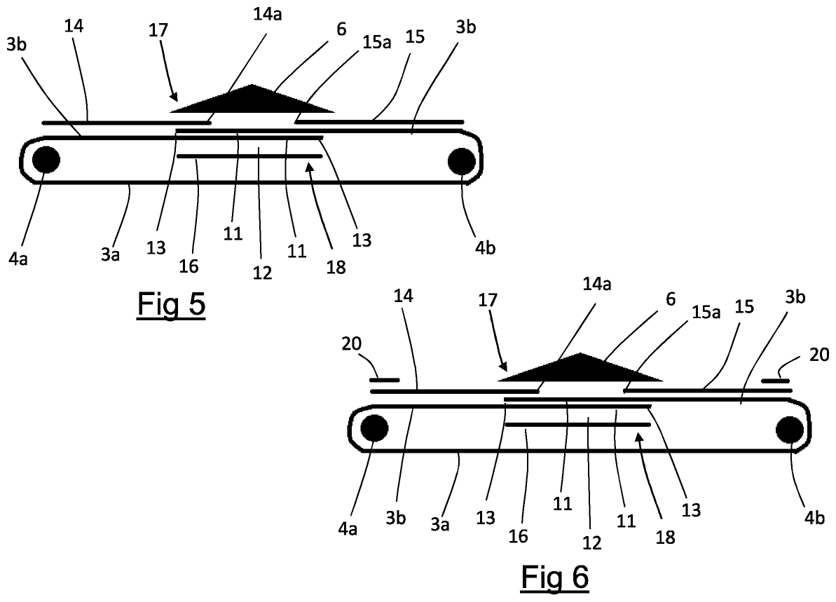

Alternatively, as illustrated in FIGS. 5 and 6, the portion of juxtaposition 12 of edges of carcass ply can be radially interposed between the tread band 6 and the protective layer 16.

In any case, a first area of juxtaposition 17 and a second area of juxtaposition 18 are defined in the tyre 100, wherein, respectively, the protective layer 16, the first sidewall reinforcing ply 14 and the portion of juxtaposition 12 of edges of carcass ply are radially juxtaposed over one another and wherein the protective layer 16, the second sidewall reinforcing ply 15 and the portion of juxtaposition 12 of edges of carcass ply are radially juxtaposed over one another.

The first area of juxtaposition 17 and the second area of juxtaposition 18 are symmetrical with respect to the equatorial plane X and are axially distanced from the equatorial plane X by a distance comprised between 6% and 24% of the width of the tyre 100.

The first area of juxtaposition 17 and the second area of juxtaposition 18 each have a width equal to or greater than 0.5% of the width of the tyre 100 and equal to or less than 10% of the width of the tyre 100.

In any case, the tread band 6 is arranged radially outside the first area of juxtaposition 17 and the second area of juxtaposition 18. The tread band 6 is radially juxtaposed over the first area of juxtaposition 17 and the second area of juxtaposition 18.

At the first area of juxtaposition 17 and the second area of juxtaposition 18, the tyre 100 has five mutually radially overlapping plies, as schematically illustrated in FIGS. 3 to 6. Such five plies are given, in the first area of juxtaposition 17, by the portion 3a of the carcass ply 3 that extends with continuity between the first annular anchoring structure 4a and the second annular anchoring structure 4b (1 ply), by the portion of juxtaposition 12 of edges of carcass ply (2 plies), by the first sidewall reinforcing ply 14 (1 ply) and by the protective layer 16 (1 ply). Such five plies are given, in the second area of juxtaposition 18, by the portion 3a of the carcass ply 3 that extends with continuity between the first annular anchoring structure 4a and the second annular anchoring structure 4b (1 ply), by the portion of juxtaposition 12 of edges of carcass ply (2 plies), by the second sidewall reinforcing ply 15 (1 ply) and by the protective layer 16 (1 ply).

In the axial space between the first area of juxtaposition 17 and the second area of juxtaposition 18, the tyre 100 has four mutually radially overlapping plies, as schematically illustrated in FIGS. 3 to 6. Such four plies are given by the portion 3a of the carcass ply 3 that extends with continuity between the first annular anchoring structure 4a and the second annular anchoring structure 4b (1 ply), by the portion of juxtaposition 12 of edges of carcass ply (2 plies) and by the protective layer 16 (1 ply).

In the axial space between the first area of juxtaposition 17 and the first annular anchoring structure 4a the tyre 100 has (without counting the possible reinforced band-shaped elements 20) three mutually radially juxtaposed plies, as schematically illustrated in FIGS. 3 to 6. Such three plies are given by the portion 3a of the carcass ply 3 that extends with continuity between the first annular anchoring structure 4a and the second annular anchoring structure 4b (1 ply), by the portion 3b of carcass ply 3 that extends between the radially juxtaposed free edges 11 and the first annular anchoring structure 4a (1 ply) and by the first sidewall reinforcing ply 14 (1 ply).

In the axial space between the second area of juxtaposition 18 and the second annular anchoring structure 4b the tyre 100 has (without counting the possible reinforced band-shaped elements 20) three mutually radially juxtaposed plies, as schematically illustrated in FIGS. 3 to 6. Such three plies are given by the portion 3a of the carcass ply 3 that extends with continuity between the first annular anchoring structure 4a and the second annular anchoring structure 4b (1 ply), by the portion 3b of carcass ply 3 that extends between the radially juxtaposed free edges 11 and the second annular anchoring structure 4b (1 ply) and by the second sidewall reinforcing ply 15 (1 ply).

The first area of juxtaposition 17 and the second area of juxtaposition 18 are preferably axially arranged at portions of the tread band 6 that do not make contact with the ground during travel in a straight line.

As schematically represented in FIG. 1, the ratio between the width of the inflated tyre L and the radius of curvature R, at any point of the tread band 6 (preferably at any point of the central portion 7 of the tread band 6), of the inflated profile of the tyre is greater than 2.0.

The ratio between the width of the inflated tyre L and the radius of curvature R, at any point of the tread band 6 (preferably at any point of the central portion 7 of the tread band 6), of the inflated profile of the tyre is less than 2.2.

The radius of curvature R of the inflated profile of the tyre along the width of the tread band 6 can be different at different points of the tread band.

The minimum radius of curvature R of the inflated profile of the tyre at the tread band 6 (preferably at the central portion 7 of the tread band 6) is equal to or more than 95% of a maximum radius of curvature R of the inflated profile of the tyre at the tread band 6 (preferably at the central portion 7 of the tread band 6).

The tyre 100 has a fitting diameter according to the ISO or ETRTO convention preferably equal to 622 mm or equal to 630 mm.

The weight of the tyre is less than 400 g, preferably less than, or equal to, 350 g.

The provision and arrangement of the first area of juxtaposition 17 and of the second area of juxtaposition 18 provides the tyre 100 with an increased structural rigidity in the portions of tyre 100 that make contact with the ground when the cyclist enters a bend and during cornering, increasing the precision of the cornering trajectory and the resistance to lateral thrusts, and makes it possible to obtain a radius of curvature of the inflated profile of the tyre 100 that is constant, or substantially constant or in any case very similar, between the portions of tyre that make contact with the ground during travel in a straight line and during cornering, substantially increasing the comfort and the sensation of safety and maneuverability of the cyclist.

The Applicant has also surprisingly noted that the provision and arrangement of the first area of juxtaposition 17 and of the second area of juxtaposition 18 improves the rolling resistance of the tyre, decreasing it.

Some tests were conducted to evaluate the performance of racing bicycle tyres in accordance with the present invention.

In particular, two tyres were tested: a reference tyre (tyre 1) and a tyre according to the present invention (tyre 2), respectively.

The two tyres have dimensions of 28-622 (ETRTO).

The two tyres are tubeless ready tyres (TLR).

The two tyres were mounted on identical rims. The rigidity of the rims is such that by applying any load to the wheel, the contribution of the rim to the overall deformation of the wheel is less than 1%.

The two tyres differ only in the following characteristics:
the reference tyre comprises, instead of the first sidewall reinforcing ply 14 and of the second sidewall reinforcing ply 15, a single reinforcing ply that extends from bead core to bead core.
the reference tyre has a ratio between the width of the inflated tyre and the radius of curvature, at any point of the tread band, of the inflated profile of the tyre of 1.96.
the tyre in accordance with the present invention has a first area of juxtaposition 17 and a second area of juxtaposition 18 arranged respectively at a distance from the equatorial plane X of 5% of the width of the tyre. Both the first area of juxtaposition 17 and the second area of juxtaposition 18 have a width equal to 8% of the width of the tyre.
the tyre in accordance with the present invention has a ratio between the width of the inflated tyre and the radius of curvature, at any point of the tread band, of the inflated profile of the tyre of 2.05.
the tyre in accordance with the present invention has the reinforcing layer 16.
tyre 2 has a weight reduced by 9% with respect to the weight of tyre 1.

Both of the tyres are equipped with identical carcass structure, identical tread band and identical reinforced band-shaped elements.

In order to conduct rolling resistance tests of the tyre each wheel (rim and tyre inflated to 5.7 bar) was mounted on top of a rotating drum of diameter of 77 centimeters applying a load of 416 N. The drum was set in rotation at a speed of 200 revolutions per minute (corresponding to about 28.8 Km/h). After 30 minutes from the start of rotation of the drum the drive torque necessary to keep the drum in rotation was detected three times, 20 seconds apart, and the average of the three detections was calculated. The difference between the average calculated for tyre 1 and for tyre 2 was interpreted as the difference in rolling resistance between the two tyres.

The test highlighted, for tyre 2, about 8% less rolling resistance with respect to tyre 1.

In order to conduct rideability tests, a racing bicycle was alternatively equipped with tyres of type 1 and 2 above. The tyres were inflated to about 5.7 bar. The bicycle was ridden by a tester over a route having an alternation of climbs, descents, flat sections, fast sections, slow sections, counter slope curves and sharp bends.

The sensations perceived by the tester are summarized in the following table, where the term “smoothness” is meant to indicate the perceived rolling resistance, the term “straight line comfort” is meant to indicate the comfort of travel perceived by the tester during travel along straights, the term “support first cornering step” is meant to indicate the ability to maintain the trajectory set during the start of a cornering step, the term “support second cornering step” is meant to indicate the ability to maintain the trajectory set during leaning in a corner, the term “sensation of safety” is meant to indicate the progressivity of cornering behavior (which substantially corresponds to the combination of values of “support first cornering step” and “support second cornering step”), and the term “reactivity” is meant to indicate the speed of transferring a drive torque to the ground.

Every symbol “+” indicates an improved behavior of about 5% with respect to a reference given by the bicycle equipped with the tyres of type 1.

| | Tyre 2 |
|---|---|
| smoothness | ++ |
| straight line comfort | +++++ |
| support first cornering step | ++++ |
| support second cornering step | +++++ |
| sensation of safety | ++++ |
| reactivity | ++ |

The present invention has been described with reference to some preferred embodiments. Various modifications can be made to the embodiments described above, still remaining within the scope of protection of the invention, defined by the following claims.

1-19. (canceled)

20. A tyre for racing bicycle wheels, comprising:
a carcass structure and a tread band arranged in a radially outer position with respect to the carcass structure;
wherein the carcass structure comprises:
a single carcass ply turned around a first annular anchoring structure and around a second annular anchoring structure, wherein free edges of the carcass ply are radially juxtaposed over one another at a portion of juxtaposition of edges of carcass ply;
a protective layer having a width equal to or less than 50% of the width of the tyre;
a first sidewall reinforcing ply axially arranged between the first annular anchoring structure and an equatorial plane (X) of the tyre; and
a second sidewall reinforcing ply axially arranged between the second annular anchoring structure and the equatorial plane (X);
wherein in a first area of juxtaposition, the protective layer, the first sidewall reinforcing ply, and the portion of juxtaposition of edges of carcass ply are radially juxtaposed according to a predetermined order;
wherein in a second area of juxtaposition, the protective layer, the second sidewall reinforcing ply, and the portion of juxtaposition of edges of carcass ply are radially juxtaposed according to a predetermined order; and
wherein the first area of juxtaposition and the second area of juxtaposition are arranged on axially opposite sides with respect to the equatorial plane (X) at respective distances from the equatorial plane (X) ranging from 3% to 24% of the width of the tyre.

21. The tyre according to claim 20, wherein the first area of juxtaposition and the second area of juxtaposition are arranged on axially opposite sides with respect to the equatorial plane (X) at respective distances from the equatorial plane (X) ranging from 5% to 20% of the width of the tyre.

22. The tyre according to claim 20, wherein the first area of juxtaposition and the second area of juxtaposition are symmetrically arranged on axially opposite sides with respect to the equatorial plane (X).

23. The tyre according to claim 20, wherein the first area of juxtaposition and the second area of juxtaposition each have a width equal to or less than 22% of the width of the tyre.

24. The tyre according to claim 20, wherein the first area of juxtaposition and the second area of juxtaposition each have a width equal to or greater than 0.5% of the width of the tyre.

25. The tyre according to claim 20, wherein the portion of juxtaposition of edges of carcass ply has a width ranging from 10% to 50%, of the width of the tyre.

26. The tyre according to claim 20, wherein the portion of juxtaposition of edges of carcass ply is symmetrically arranged with respect to the equatorial plane (X).

27. The tyre according to claim 20, wherein the protective layer is symmetrically arranged with respect to the equatorial plane (X).

28. The tyre according to claim 20, wherein the first sidewall reinforcing ply and the second sidewall reinforcing ply are radially outer with respect to the carcass ply.

29. The tyre according to claim 20, wherein the protective layer is radially arranged between the tread band and a portion of the carcass ply extending continuity between the first annular anchoring structure and the second annular anchoring structure.

30. The tyre according to claim 29, wherein the protective layer is radially arranged between the tread band and the portion of juxtaposition of edges of carcass ply.

31. The tyre according to claim 29, wherein the portion of juxtaposition of edges of carcass ply is radially arranged between the tread band and the protective layer.

32. The tyre according to claim 20, wherein the tread band has a width at least equal to the width of the protective layer.

33. The tyre according to claim 20, wherein the reinforcing layer has a thickness in the radial direction ranging from 0.25 millimeters to 0.55 millimeters.

34. The tyre according to claim 20, wherein the first sidewall reinforcing ply and the second sidewall reinforcing ply have respective thicknesses in the radial direction ranging from 0.15 millimeters to 0.55 millimeters.

35. The tyre according to claim 20, wherein the carcass ply comprises a plurality of reinforcing cords inclined with respect to the equatorial plane (X), by a first angle ranging from 30° to about 60°.

36. The tyre according to claim 20, wherein the reinforcing layer comprises a square fabric with reinforcing cords of the weft or of the warp oriented with respect to the equatorial plane with an angle greater than 25°.

37. The tyre according to claim 20, wherein the tyre has an inflation pressure greater than 3.5 bar.

38. The tyre according to claim 20, wherein the tyre has a weight equal to or less than about 400 grams.

39. The tyre according to claim 23, wherein the first area of juxtaposition and the second area of juxtaposition each have a width equal to or less than 10% of the width of the tyre.

40. The tyre according to claim 24, wherein the first area of juxtaposition and the second area of juxtaposition each have a width equal to or greater than 2% of the width of the tyre.

41. The tyre according to claim 24, wherein the first area of juxtaposition and the second area of juxtaposition each have a width equal to or greater than 5% of the width of the tyre.

42. The tyre according to claim 25, wherein the portion of juxtaposition of edges of carcass ply has a width ranging from 20% to 40%, of the width of the tyre.

43. The tyre according to claim 36, wherein the reinforcing layer comprises a square fabric with reinforcing cords of the weft or of the warp oriented with respect to the equatorial plane with an angle greater than 30°.

44. The tyre according to claim 36, wherein the reinforcing layer comprises a square fabric with reinforcing cords of the weft or of the warp oriented with respect to the equatorial plane with an angle greater than 45°.

45. The tyre according to claim 38, wherein the tyre has a weight equal to or less than about 350 grams.
